(19) United States
(12) Patent Application Publication
(10) Pub. No.: US 2010/0096553 A1
(43) Pub. Date: Apr. 22, 2010

(54) REFLECTIVE OPTICAL SENSOR AND SWITCHES AND SYSTEMS THEREFROM

(75) Inventors: Swapnil Gopal Patil, Thane (IN); Marek Gierczak, Meylan (FR)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/256,419

(22) Filed: Oct. 22, 2008

(51) Int. Cl. G01J 5/02

(52) U.S. Cl. 250/341.8

(57) ABSTRACT

A reflection-based optical sensor device (100) for detecting a presence of an object (110) having a detection surface (111) includes a housing (115) having first and second open volumes (120,130) including a central common portion (140) for isolating the first and second volumes. A light emitter (122) for emitting an irradiation beam (141) is contained within the first volume of the housing, wherein the light emitter is positioned in the housing so that the irradiation beam is aligned within 5 degrees of a surface normal of the detection surface (111). A light detector (132) has a detection plane (133) contained within the second volume of the housing, wherein the light detector is positioned in the housing so that the normal from the detection plane (133) is aligned within 5 degrees of the surface normal of the detection surface (111). At least one optical device (150) is secured to the housing (115) and positioned in a path of the irradiation beam having a first portion for tilting said irradiation beam to provide a tilted irradiation beam (142) at an angle for reaching the detection surface (111), wherein a reflected or backscattered beam (143) emerges from the detection surface (111) of the object responsive to the tilted irradiation beam (142). The optical device (150) includes a second portion (152) that is positioned laterally from the first portion (151), wherein the detection plane (133) of the detector is in optical alignment with said second portion (152) for sensing the reflected or backscattered beam (143).

### FIELD OF THE INVENTION

Embodiments of the invention relate to a reflective type optical sensor device having a light emitting element and a light detecting element for detecting an object by sensing the light which is emitted from the light emitting element and reflected or backscattered by a detected object by the detecting element.

### BACKGROUND

Photo reflective sensors can be used in a variety of applications where there is a need to determine presence or the absence of certain objects. For example, security systems, conveyer belts, door locking systems, hand dryers, light curtains, seat belt position sensors, revolution counters, and safety keys are common reflective sensor applications. A photo reflective sensor comprises a light emitter (e.g. infrared laser or infrared light emitting diode (LED)) and a light detector (e.g. phototransistor or photodiode based). When the output of the detector is coupled to a switch, the resulting device is generally referred to as a photo reflective switch.

When an object to be detected comes in the path of the light beam emitted by the light emitter, a portion of the light will be reflected or backscattered by the object. Detection of the reflected or backscattered light by the light detector at a sufficient intensity indicates the presence of the object. This sensing arrangement generally requires the emitting surface of the emitter and the detecting surface of the detector to be tilted relative to one another so that the light reflected or backscattered by the object (that obeys the law of reflection) is received at the detecting surface.

Tilting the emitter and the detector has certain disadvantages, particularly in conventional non-integrated sensor embodiments (i.e. the emitter and detector are not formed on a common substrate (e.g. silicon substrate)). In such conventional embodiments, it is generally difficult to hold constant the required angle between emitter and detector for detection since these components tend to shift in position during assembly processing. Tilting the emitter and the detector may result in the need for a different housing and printed circuit board (PCB) for different distances (D) to the object to be detected since as known in the art a different angle for both the emitter and detector is required for different D. Moreover, the assembly processing for conventional non-integrated sensor embodiments also tends to be a tedious assembly process due to the required alignment of the emitter and the detector. Moreover, such an arrangement generally makes it difficult to get a sealed/ingress protected sensor because different lenses are generally required for the emitter and detector and these respective lenses need to be angled at essentially the same angle as the angle of the emitter and detector. Requiring these two lenses be tilted at an angle makes welding/joining process more complicated and difficult to control, and as a result, more prone to fail in sealed/ingress protection (leak) testing.

### SUMMARY

This Summary is provided to comply with 37 C.F.R. §1.73, presenting a summary of the invention to briefly indicate the nature and substance of the invention. It is submitted with the understanding that it will not be used to interpret or limit the scope or meaning of the claims.

Embodiments of the present invention describe new reflective optical sensors and switches, systems therefrom and methods for detecting an object having a detection surface using a reflection-based optical sensor device. In one embodiment of the invention, a reflection-based optical sensor device for detecting a presence of an object having a detection surface comprises a housing having first and second open volumes including a central common portion for isolating the first and second volumes. A light emitter for emitting an irradiation beam is contained within the first volume of the housing, wherein the light emitter is positioned in the housing so that the irradiation beam is aligned within 5 degrees of a surface normal of the detection surface. A light detector has a detection plane contained within the second volume of the housing, wherein the light detector is positioned in the housing so that the normal from the detection plane is aligned within 5 degrees of the surface normal of the detection surface. At least one optical device is secured to the housing and positioned in a path of the irradiation beam having a first portion for tilting said irradiation beam to provide a tilted irradiation beam at an angle for reaching the detection surface, wherein a reflected or backscattered beam emerges from the detection surface of the object responsive to the tilted irradiation beam. The optical device includes a second portion that is positioned laterally from the first portion, wherein the detection plane of the detector is in optical alignment with said second portion for sensing the reflected or backscattered beam.

### BRIEF DESCRIPTION OF THE DRAWINGS

FIG. 1 is a sectional view of a reflection-based optical sensor device for detecting a presence of an object having a detection surface, according to an embodiment of the invention.

FIG. 2 is a plot of scanning range as a function of prism angle for the exemplary optical sensor device shown in FIG. 1.

FIG. 3 is an exploded depiction a sensor device according to an embodiment of the invention including a printed circuit board (PCB) having a detector and an emitter coupled thereto, along with electronics on the PCB associated with the detector and the emitter.

FIG. 4 illustrates part of a security system that represents one application for sensor devices according to embodiments of the invention.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

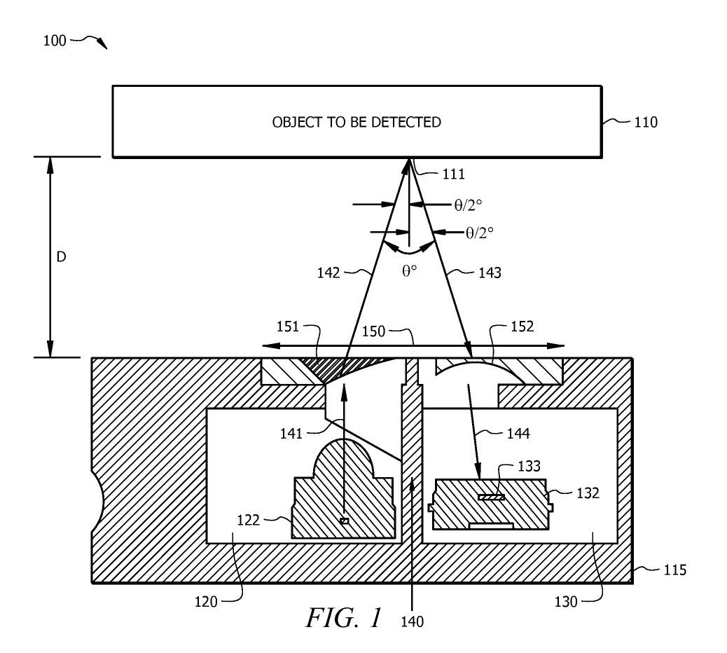

FIG. 1 is a sectional view of a reflection-based optical sensor device 100 for detecting the presence of an object to be detected 110 having a detection surface 111, according to an embodiment of the invention. Sensor 100 is shown at a distance D from the detection surface 111 of the object 110.

Sensor device 100 includes a housing 115 having first open volume 120 and second open volume 130 including a central common portion 140 for isolating the first and second volumes 120 and 130, wherein the isolating generally comprises physical as well as optical isolation. Housing 115 generally comprises a polymeric material that is non-optically transparent to infrared radiation, such as made from conventional non-optically transparent plastic materials such as acrylonitrile butadiene styrene (ABS), polycarbonate, synthetic polyamides such as Nylon, or polybutylene terephthalate (PBT).

A light emitter 122 is contained and generally secured within the first volume 120 of the housing 115, wherein the light emitter emits an irradiation beam 141. The light emitter can comprise a laser or an LED, such as infrared laser or infrared LED. However, the light emitter can emit light in other portions of the electromagnetic spectrum, including ultraviolet or visible light. It can be seen that the light emitter 122 is positioned in the housing 115 so that the irradiation beam 141 is aligned within 5 degrees (e.g. within 2 or 3 degrees) relative to a surface normal of the detection surface 111. Light emitter 122 generally emits narrowband radiation.

A light detector 132 which includes a light sensitive detection plane 133 is contained and generally secured (e.g. attached with an adhesive or welded) within the second volume 130 of the housing 115. Light detector 132 can generally comprise any suitable light detector, such as based on CCDs, avalanche diodes, phototransistors, or photodiodes. The detector 132 is shown positioned so that a normal from its detection plane 133 is aligned within 5 degrees (e.g. within 2 or 3 degrees) relative to the surface normal of the detection surface 111.

At least one optical device 150 is secured to the housing 115 which includes a first portion 151 positioned in a path of the irradiation beam 141 for tilting the irradiation beam to provide a tilted irradiation beam 142 having an angle shown as θ/2 relative to a normal to detection surface 111, for irradiating the detection surface 111 of the object 110. The first portion 151 may comprises a prism-like shaped optical object as shown in FIG. 1 for refracting the irradiation beam 141, but can also generally comprise any arrangement of optical elements capable of tilting the irradiation beam, which as known in the art can include certain lenses, lenses coupled with prisms, mirrors, and mirrors coupled with lens.

A reflected or backscattered beam 143 having an angle shown as θ/2 relative to a normal to detection surface 111 emerges from the detection surface of the object 110 responsive to the tilted irradiation beam 142. As known in the art, the angle of reflected or backscattered beam 143 relative to the tilted irradiation beam 142 is based on the well known law of reflection.

Optical device 150 is shown having a second portion 152 positioned laterally from the first portion 151. The detection plane 133 of the detector 132 is in optical alignment with the second portion 152 for sensing the reflected or backscattered beam 143. As shown in FIG. 1, second portion 152 comprises a collimating lens that focuses the reflected or backscattered beam 143 to provide a focused reflected beam 144. However, in other embodiments second portion 152 may comprise optics described above such as certain lenses, prisms, lenses coupled with prisms, mirrors and mirrors coupled with lenses.

One of the advantages of sensor 100 is that its detecting distance D can be varied by changing only the optical device 150 for sensing the presence of an object at a particular D. Accordingly, unlike conventional reflection-based optical sensors, all other sensor system components and positions (e.g. angles) thereof including the housing 115, emitter 122 and detector 132 can remain unchanged because the angle of the tilted irradiation beam 142 (of about θ/2) when the emitter 122 is kept straight (not tilted) is determined essentially entirely by optics comprising the first portion 151 of the optical device 150 (e.g. the prism angle when first portion 151 comprises a prism).

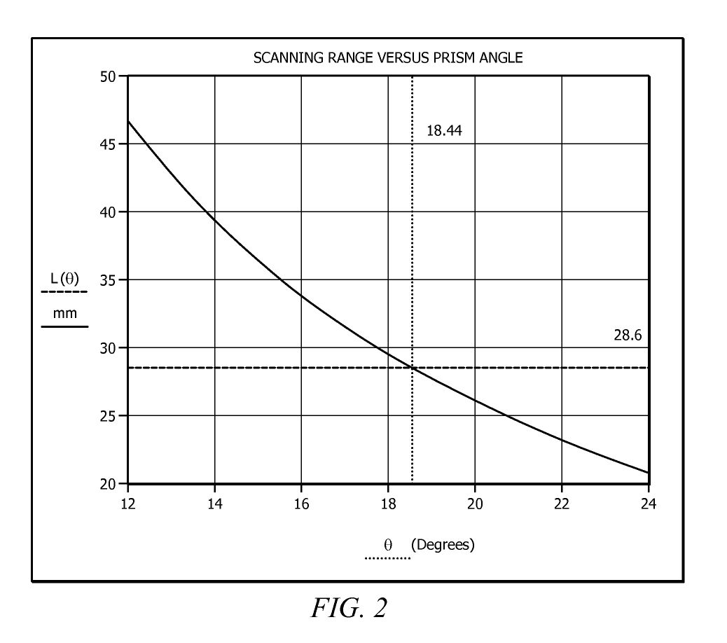

FIG. 2 shows an plot of scanning range (=D shown in FIG. 1) as a function of prism angle for sensor 100. It can be seen that the first portion 151 of the optical device 150 (e.g. lens or prism) can be adapted to operate at a specific scanning distance (D) by setting an appropriate angle for the first portion 151 of the optical device 150 (e.g. lens or prism) to achieve the desired angle of the tilted irradiation beam 142 (of about θ/2). For example, as shown in FIG. 2, a scanning distance (D) of 28.6 mm can be set using a prism angle of about 18.44 degrees.

Most of the assembly processing for sensors according to embodiments of the invention can thus remain essentially unchanged independent of the scanning range (=D) required for a given application. Sensor differentiation (i.e. customized for a particular scanning range (=D) application) can be carried out at the last assembly operation (e.g. configuring/angling first portion 151 and second portion 152 of the optical device 150 then securing the optical device 150). Assembly is simplified by being able to use a non-tilted emitter 122 and detector 132 and customization is simplified by only needing to configure and secure the optical device 150. Moreover, since there is no need to tilt the emitter 122 and detector 132 or have two different angled lenses which as described above makes the welding/joining process more complicated and difficult to control for conventional optical sensors, optical sensors according to embodiments of the invention are better able to pass ingress protection (leak) testing.

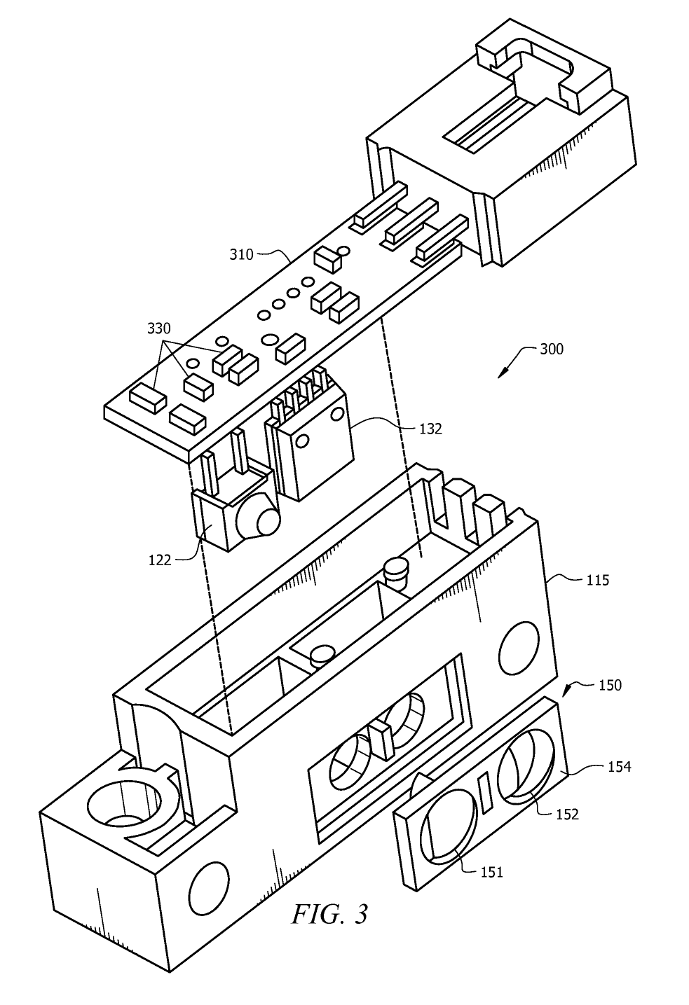

In a typical embodiment, the detector 132 and emitter 122 are mounted (e.g. welded or attached via an adhesive) on a PCB, where the electronics for the detector 132 and emitter 122 and the electrical interconnects between the respective components are provided on the PCB. FIG. 3 shows an exploded depiction a sensor device 300 according to an embodiment of the invention including a PCB 310 having a detector 132 and an emitter 122 coupled thereto, along with electronics 330 on the PCB 310 associated with the detector 132 and the emitter 122, housing 115, and optical device 150. Optical device 150 is shown including a supporting structure 154, upon which first portion 151 and second portion 152 are secured thereto. The supporting structure 154 can be welded to the housing 115, such as by the process of ultrasonic welding to seal the sensor device 300. In another embodiment (not shown), first portion 151 and second portion 152 are not secured together, such as when they are individually secured directly to the housing 115.

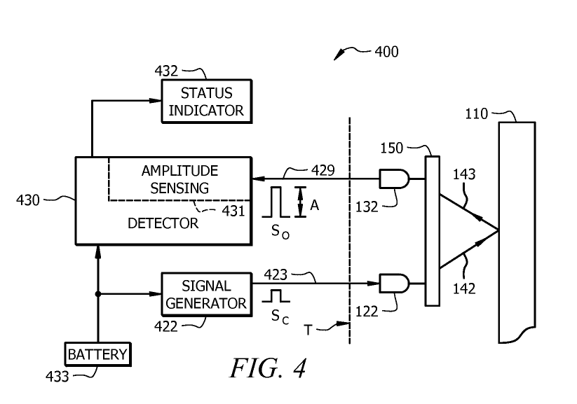

FIG. 4 illustrates part of a security system 400 that represents one application for sensor devices according to embodiments of the invention. Security system 400 may be mounted on a door frame or window frame (not shown). System 400 includes a signal generator 422 which is coupled over a line 423 to emitter 122 which is generally a light source, for example, an infrared LED which generates a transmission signal (infrared light) when energized by a command signal Sc from signal generator 422. Transducer detector 132, for example, a light receiver such as an infra-red sensor unit, is included in system 400 to receive reflected or backscattered signal 143 from object 110. When signal generator 422 energizes emitter 122, an infrared signal is emitted which is tilted by optical device 150 as shown.

A detector 430 detects an electrical output signal So generated by transducer detector 132 over line 429 in response to receipt of a reflected transmission from transducer detector 132. Detector 430 includes amplitude detection circuitry 431. The amplitude A of the signal So generated by transducer detector 132 is a function of the amount of energy received. If the object 110 moves to its predetermined position, the amount of energy received by transducer detector 132 is a maximum and the amplitude A of the signal generated is a peak value. As the door, window or other object 110 is moved away from its reference position, the amount of energy received by transducer detector 132 is reduced. The amplitude of the resulting signal generated by transducer detector 132 is correspondingly less than the peak value. Amplitude detection circuitry 431 senses the amplitude level of the output signal So from the transducer detector 132 and compares this level with a predetermined threshold value. When the output signal amplitude is within an acceptable range of values, detector 430 provides an appropriate output to a status indicator/alarm 432 of the security system 400. Status indicator/alarm 432 generally includes at least one switch which can be operable for turning on a light or an audible alarm when the signal amplitude is outside an acceptable range. If the signal amplitude falls outside this range, detector 430 provides an appropriate output of this condition to status indicator 432 as well.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

1. A reflection-based optical sensor device for detecting a presence of an object having a detection surface, comprising:
a housing having first and second open volumes, the housing further including a central common portion that physically and optically isolates said first and second volumes;
a light emitter contained within said first volume of said housing, said light emitter for emitting an irradiation beam, wherein said light emitter is positioned in said housing so that said irradiation beam is aligned within 5 degrees of a surface normal of said detection surface;
a light detector contained within said second volume of said housing, said light detector including a detection plane, wherein said light detector is positioned in said housing so that a normal from said detection plane is aligned within 5 degrees of said surface normal of said detection surface;
at least one optical device secured to said housing having a first portion, positioned in a path of said irradiation beam and between said light emitter and said detection surface, for tilting said irradiation beam to provide a tilted irradiation beam at an angle for reaching said detection surface of said object, wherein a reflected or backscattered beam emerges from said detection surface of said object responsive to said tilted irradiation beam,
said optical device having a second portion positioned laterally from said first portion, wherein said detection plane of said detector is in optical alignment with said second portion for sensing said reflected or backscattered beam.

2. The sensor of claim 1, wherein said detector is positioned so that the normal from said detection plane is aligned along said surface normal of said detection surface.

3. The sensor device of claim 1, wherein said first portion of said optical device comprises a prism and said second portion of said optical device comprises a collimating lens.

4. The sensor device of claim 1, wherein said optical device comprises a holding structure, wherein said holding structure is secured to said housing.

5. The sensor device of claim 4, wherein said holding structure comprises a metal, wherein said holding device is welded to said housing.

6. The sensor device of claim 1, wherein light emitter comprises an infrared emitter.

7. The sensor device of claim 1, further comprising a printed circuit board (PCB), wherein said light emitter and said light detector are mounted on said PCB.

8. The sensor device of claim 1, wherein said housing comprises a polymeric material that is non-optically transparent to infrared radiation.

9. The sensor device of claim 1, wherein said light emitter is positioned in said housing so that said irradiation beam is aligned within 2 degrees of said surface normal of said detection surface and said light detector is positioned in said housing so that said normal from said detection plane is aligned within 5 degrees of said surface normal of said detection surface.

10. A method for detecting an object having a detection surface using a reflection-based optical sensor device comprising a housing having first and second open volumes that are physically and optically isolated, and at least one optical device secured to said housing, comprising:
securing a light emitter within said first volume of said housing;
aligning said light emitter within 5 degrees of a surface normal of said detection surface;
securing at least one optical device to said housing between said light emitter and said detection surface, said at least one optical device including a first portion and a second portion, said second portion positioned laterally from said first portion;
emitting an irradiation beam from said light emitter;
securing a light detector within said second volume of said housing, said second volume physically and optically isolated from said first volume, said light detector having a detection plane;
positioning said light detector so that a normal from said detection plane is aligned within 5 degrees of said surface normal of said detection surface;
tilting said irradiation beam using the first portion of said optical device to provide a tilted irradiation beam having an angle for reaching said detection surface of said object, wherein a reflected or backscattered beam emerges from said detection surface of said object responsive to said tilted irradiation beam,
receiving said reflected or backscattered beam at the second portion of said optical device, and
detecting said reflected or backscattered beam at said light detector.

11. The method of claim 10, wherein said irradiation beam comprises an infrared beam.

12. The method of claim 10, further comprising the step of coupling an output signal from said light detector to control a position of a switch.
